(19) United States
(12) Patent Application Publication
(10) Pub. No.: US 2018/0007045 A1
(43) Pub. Date: Jan. 4, 2018

(54) SECURE CODING AND MODULATION FOR OPTICAL TRANSPORT

(71) Applicants: Mehdi Arashmid AKHAVAIN MOHAMMADI, Ottawa (CA); Mohammad Mehdi MANSOURI RAD, Kanata (CA); Hamid MEHRVAR, Ottawa (CA)

(72) Inventors: Mehdi Arashmid AKHAVAIN MOHAMMADI, Ottawa (CA); Mohammad Mehdi MANSOURI RAD, Kanata (CA); Hamid MEHRVAR, Ottawa (CA)

(21) Appl. No.: 15/198,441

(22) Filed: Jun. 30, 2016

(51) Int. Cl. H04L 29/06; H04B 10/516; H04B 10/66; H04B 10/27

(52) U.S. Cl. CPC H04L 63/0876; H04L 63/061; H04B 10/27; H04B 10/516; H04B 10/66

(57) ABSTRACT

Transmitter, receiver, system and method for secure data communications are provided. The transmitter encodes data as a spatial symbol in accordance with a codebook to transmit spatially encoded data through the optical channel. The receiver detects a spatial symbol from spatially encoded data received through the optical channel, and generates a data value based on a codebook and the spatial symbol.

### TECHNICAL FIELD

The present invention relates to data communications, and more specifically to secure data communications over optical channels.

### BACKGROUND

The volume of data processed in a data center (DC) is sharply on the rise. As the use of DCs grows, so does the demand placed on individual data centers. To address this concern, multi-site data centers have become more prominent. Growth in inter-site DC traffic is increasing. Security of inter-site DC traffic has become a vulnerability. Various security methods have been developed to prevent unauthorized access to sensitive information transmitted between DC sites. DC operators can suggest that all tenants enable encryption for all communications. This may increase the security of any encrypted message, but it is difficult if not impossible for the DC operator to ensure that the tenants are in fact using encryption. The DC operator can route inter-site traffic through secure tunnels so that all traffic is sent through the tunnel is encrypted. One drawback to the use of secure tunnels is that the encryption and decryption applied at either end of the tunnel increase the operational expense of inter-site traffic. As the length of the encryption keys increase, so too does the increase in the operational expense. A general drawback of the use of encryption (either bulk encryption of the channel or the encryption of the different messages) is that any party that is able to intercept the traffic can store a copy of the transmitted data to enable an offline attack on the encryption. It should be understood that encryption is performed on the data in the digital domain, and is thus subject to storage and conventional attacks on digitally encrypted data. Similar problems have been identified in other networking scenarios including in metro-wide networks.

A secure mechanism to transmit data over an optical channel that is more resistant to decoding attempts by third parties may address some of the above described security needs.

### SUMMARY

The following presents a summary of some aspects or embodiments of the disclosure in order to provide a basic understanding of the disclosure. This summary is not an extensive overview of the disclosure. It is not intended to identify key or critical elements of the disclosure or to delineate the scope of the disclosure. Its sole purpose is to present some embodiments of the disclosure in a simplified form as a prelude to the more detailed description that is presented later.

In a first aspect of the present invention, there is provided a transmitter for secure transmission of data over an optical channel. The transmitter comprises a mask and a controller. The mask allows for the transmission of a spatial symbol into the optical channel. The controller is configured to encode incoming data as a spatial symbol in accordance with a first codebook, and control the mask based on the spatial symbol to transmit the spatial symbol through the optical channel.

In embodiments of the first aspect of the present invention the mask is disposed between a light source and the optical channel. In another embodiment, the controller comprises a region controller configured to control each of a plurality of regions of the mask based on the symbol. In a further embodiment, each region in the plurality is operable as one of a polarizer, an attenuator, a phase shifter, a dispersive element and combinations thereof. In another embodiment, the transmitter is configured to change the codebook. In a further embodiment, the transmitter is configured to change the codebook in response to one of a message received from a controller; a message received from a receiver of the spatial symbol; a timer internal to the transmitter; and detection of an event, and optionally the transmitter is further configured to notify at least one of the receiver and the controller of a change of the codebook. In another embodiment, the transmitter is configured to generate a second codebook different from the first codebook; and use the second codebook in a subsequent encoding. In a further embodiment, transmitter is configured to receive a new codebook from a controller or a receiver. In yet another embodiment, the controller comprises a spatial encoder configured to map the incoming data to the spatial symbol in accordance with the codebook.

In a second embodiment of the present invention, there is provided a method for secure data transmission over an optical channel. The method comprises encoding incoming data as a spatial symbol in accordance with a codebook; and transmitting the spatial symbol through the optical channel.

In an embodiment of the second aspect, the method further comprises controlling the configuration of a mask to transmit light into the optical channel in accordance with a shape of the spatial symbol. In a further embodiment, transmitting includes transmitting a light through the mask. In another embodiment, controlling the mask comprises controlling each of a plurality of regions of the mask based on the symbol. In another embodiment, the method further comprises changing the codebook after transmitting the spatial symbol, and optionally instructing a receiver to change a codebook for data decoding in the receiver.

In a third aspect of the present invention, there is provided a receiver for secure data communication over an optical channel. The receiver comprises a mask and a controller. The mask receives a spatially encoded symbol over the optical channel, and based on the detection of the spatially encoded symbol generates a signal representative of the signal. The controller is configured to identify the received symbol in accordance with the generated signal; and decode the spatial symbol into a data value in accordance with a codebook.

In an embodiment of the third aspect, the controller is further configured to identify the received symbol in accordance with the generated signal and the codebook. In another embodiment, the receiver is configured to change the codebook. In a further embodiment, the receiver is configured to change the codebook in response to one of: a message received from a controller; a message received from a transmitter of the detected spatially encoded symbol; a timer internal to the receiver; and detection of an event, and is further optionally configured to instruct a transmitter communicatively coupled to the receiver to change a codebook for data encoding in the transmitter.

In a fourth aspect of the present invention, there is provided a method for decoding spatially encoded data received over an optical channel. The method comprises generating a signal based on spatially encoded data received over the optical channel; identifying a spatial symbol from the signal; and decoding the spatial symbol into a data value in accordance with a codebook.

In an embodiment of the fourth aspect, identifying the spatial symbol includes identifying the spatial symbol in accordance with the codebook. In another embodiment the method includes changing the codebook after decoding the spatial symbol. In another embodiment, the method includes instructing a transmitter to change a codebook for data encoding in the transmitter.

In a fifth aspect of the present invention, there is provided a method for secure data communications over an optical link. The method comprises encoding a first block of data into a first symbol for transmission using a first codebook associating a spatial symbol with a block of data; transmitting the first symbol over the optical link; encoding a second block of data into a second symbol for transmission using a second codebook, different from the first codebook; and transmitting the second symbol over the optical link.

In an embodiment of the fifth aspect, the second codebook includes a symbol different from the symbols within the first codebook. In another embodiment the number of symbols forming the second codebook is different from the number of symbols forming the first codebook. In another embodiment, each symbol is mapped to a block of data, and wherein the first codebook defines a first symbol to data block mapping, and the second codebook defines a second symbol to data block mapping different from the first symbol to data block mapping. In another embodiment, the method includes generating a dynamic look up table to switch between the first codebook and the second codebook. In another embodiment, the first codebook and the second codebook are defined by using a cryptographically secure pseudorandom sequence. In a further embodiment, each of the first symbol and the second symbol is transmitted by using a mask disposed between a light source and the optical channel. In a further embodiment, the mask is operable as a polarizer, an attenuator, a phase shifter or combinations thereof In a further embodiment, the method includes controlling the mask based on the first symbol to transmit the first symbol, and controlling the mask based on the second symbol to transmit the second symbol. In another embodiment, the method includes transmitting a trigger to a receiver to instruct the receiver to change codebooks for data decoding, and optionally trigger is transmitted over an out-of-band channel in the optical link. In a further embodiment, the method includes receiving a trigger to switch from the first codebook to the second codebook, and optionally the trigger is received over an out-of-band channel in the optical link. In a further embodiment, the method includes forming each block of data by extracting a portion from each of a plurality of data streams.

In a sixth aspect of the present invention, there is provided a method for secure data communications over an optical link. The method comprises receiving a first symbol over the optical link; decoding the first symbol into a first block of data using a first codebook associating a geometric symbol with a block of data; receiving a second symbol over the optical link; and decoding the second symbol into a second block of data using a second codebook, different from the first codebook.

In an embodiment of the sixth aspect of the present invention, the second symbol includes a symbol different from the first symbol. In another embodiment, the number of symbols forming the second symbol is different from that of the first symbol. In a further embodiment, symbol is mapped to a data block, and wherein the first codebook defines a first symbol to data block mapping, and the second codebook defines a second symbol to data block mapping different from the first. In another embodiment, the method further includes generating a dynamic look up table to switch between the first codebook and the second codebook. In another embodiment the method includes receiving a trigger transmitter to switch from the codebook to the second codebook, and optionally the trigger can be received over an out-of-band channel in the optical link. In a further embodiment, the method includes detecting a predefined symbol to switch from the first codebook to the second codebook. In another embodiment, the method includes transmitting a trigger to a transmitter to instruct the transmitter to change codebooks for data encoding, where optionally the trigger is transmitted over an out-of-band channel in the optical link. In another embodiment, the method comprises the steps of constructing a first data stream by combining a portion from the first block of data and a portion from the second block of data.

In further aspects of the present invention, there are provided computing platforms having inputs and output interfaces, a memory and a processor. The memory can store instructions that when executed by the processor cause the computing platform to carry out the methods of above aspects of the present invention.

### BRIEF DESCRIPTION OF THE DRAWINGS

For a more complete understanding of this disclosure, reference is now made to the following brief description, taken in connection with the accompanying drawings and detailed description.

FIG. 1 is a diagram showing one example of a transmission mask;

FIG. 2 is a diagram showing a symbol set defined by controlling regions of the transmission mask of FIG. 1;

FIG. 3 is a diagram showing the superpositioning of the symbol set of FIG. 2 on the mask of FIG. 1;

FIG. 4 is a diagram showing an example of a second symbol set using the mask of FIG. 1;

FIG. 5 is a block diagram showing an exemplary embodiment of a transmitter;

FIG. 6 is a block diagram showing an exemplary embodiment of a receiver;

FIG. 7 is a block diagram showing one example of an optical system including the transmitter and the receiver;

FIG. 8 is a flow chart showing one example of a method of spatially encoding data for transmission over an optical channel;

FIG. 9 is a flowchart showing one example of a method of decoding spatially encoded data received over an optical channel;

FIG. 10A is a cross-sectional view of one example of a multicore fiber;

FIG. 10B is a diagram showing a mask corresponding to the multicore fiber shown in FIG. 10A;

FIG. 11 is a block diagram of a computing platform for implementing the controller of either FIG. 5 or FIG. 6; and

FIG. 12 is a block diagram illustrating an implementation of a receiver such as that illustrated in FIG. 6.

### DETAILED DESCRIPTION

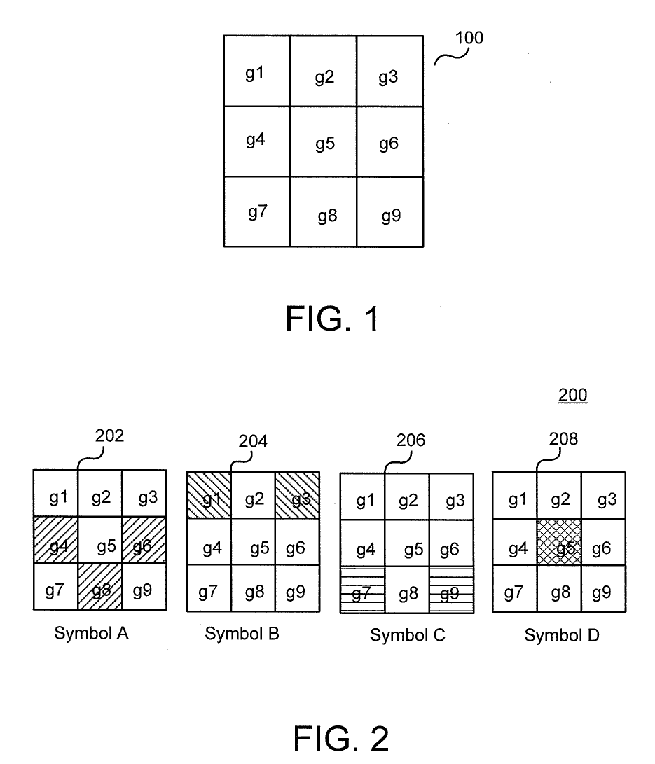

Systems and methods for secure traffic in optical links are described below, by way of example only, with reference to FIGS. 1-11. To enhance the security of transmitting in an optical channel, the systems and methods disclosed below take advantage of the ability to transmit a signal in at least one selected area in the channel. By being able to transmit a signal in a selected area, the data to be transmitted can be spatially encoded for transmission. In a simple embodiment, a set of spatial symbols is used to represent a block of data (also referred to as a data block). Without a priori knowledge of the particular codebook used for the transmission, an intercepting party would not know how to decode the transmission. Although using different regions of an optical channel is known, typically this has been done for the purposes of spatial multiplexing, not spatial encoding of data. To further increase the security, the codebook used to encode the data into spatial symbols can be changed during the transmission. So long as the transmitter and receiver are synchronized for these changes, there is no difficulty in decoding a transmission. However, an intercepting party without knowledge of when and how the codebook is changing will be further disadvantaged. This greatly increases the difficulty of attacking the encoding, and is further aided by the fact that the spatially encoded optical signal cannot be effectively stored so that it could be subjected to an offline attack. Each spatial encoding scheme may uniquely associate a set of symbols with a block of data. A set of symbols may have one symbol or a plurality of different symbols, which may be defined by using a mask.

The term “mask” described herein may generally refer to a physical element, and may be designed to correspond to an entire cross sectional area of a media available for carrying optical signals. The mask may be composed of a plurality of regions. Each region may be set in one of different states.

The term “system” described herein may generally refer to a computer based system and may include multiple (computer) components or installations operably connected to each other, each of which may include one or more programmable processors, one or more memories, components for network communications, and one or more hardware and/or software based user interfaces.

Various operations may be described herein using multiple actions in turn, by way of example only. The operations/actions described herein may be implemented in a different order, and the present disclosure is not limited to those specific examples.

In one embodiment, to allow spatial encoding of information, a transmitter makes use of a constant light source (e.g. a laser or a LED light source) that is directed towards the optical channel. Between the light source and the optical channel is a mask. FIG. 1 illustrates one example of such a mask 100. The mask 100 is divided into a plurality of independent regions, illustrated in FIG. 1 as regions g1-g9. Each of these regions can independently perform a transformation on the incident light. In the simplest embodiment, each of the regions can be controlled either to transmit the incident light or to block the incident light. By controlling which of the regions allows the light to be transmitted, the mask 100 can be used to control where in the optical channel the light is transmitted. Because each of the regions is independently controllable, the mask 100 can be used to modulate the source light so that it is encoded with data for transmission. By defining different geometric patterns on the mask 100, symbols can be created. The symbols can be mapped to data values. This allows an incoming data stream to be mapped to geometric symbols that are transmitted over the optical channel. In controlling the mask 100, each region g1-g9 can be controlled so that it has a first state and a second state. Each symbol can then be defined as a combination of one or more regions with the first state and the remaining regions with the second state. The number of regions forming the mask 100 (mask's resolution) determines the maximum number of symbols available to be chosen. For example, the mask 100 has 9 regions. If there are two states per region, then there are a total number of 2⁹=512 combinations, and thus 512 symbols can be defined.

FIG. 2 illustrates one example of a symbol set 200. This illustrative symbol set is composed of 4 symbols, A 202, B 204, C, 206 and D 208. Each symbol A-D is formed by controlling the regions of mask 100 so that a geometric symbol is formed. Light passing through mask 100 will transmitted through only selected areas of the channel. For illustrative purposes, regions in a first state are shown without shading, and regions in the second state are shown with shading. Symbol A 202 is formed by setting regions g1-g3, g5, g7, and g9 to the first state and regions g4, g6, and g8 to the second state. Symbol B 204 is formed by setting regions g2 and g4-g9 to the first state and regions g1 and g3 to the second state. Symbol C 206 is formed by setting regions g1-g6 and g8 to the first state and regions g7 and g9 to the second state. Symbol D 208 is formed by setting regions g1-g4 and g6-g8 to the first state and region g5 to the second state. In the present example, regions in the first state allow light to pass through while regions in the second state are opaque to the light. Those skilled in the art will appreciate that this example is based on a mask that attenuates the amplitude of incident light. In another example, the regions in the first state may weakly attenuate the incident light while those in the second state may more heavily attenuate the light. If more attenuation levels are possible, then more symbols could be defined using different attenuation levels for each of the regions. In some embodiments, the mask can be controlled to affect the phase or polarization of the incident light. In such embodiments, the first and second (and other subsequent) states could be defined in terms of an applied phase shift or in terms of the presence of a given polarization (e.g. regions in the first state may impose a +45° degree phase shift to the incident light and regions in the second state may impose a −45° phase shift; or regions in the first state may allow incident light to pass through unmodified, while regions in the second state may filter the incident light so that only y polarized light is propagated). A mask may also control combinations of any of amplitude, phase and polarization. Such multi-function masks may be implemented through a combination of single purpose masks.

It will be understood by those skilled in the art that the symbols in symbol set 200 are geometric symbols created by controlling regions in mask 100. The geometric symbols can be used to spatially encode data for transmission in the optical channel. If a cross-section of the channel is taken, symbols can be seen as areas of the cross-section that carry the data. Thus, light is propagated through a channel, and by controlling where in the channel the light is carried, the transmitter can make use of spatial encoding to transmit data. A party that is able to tap the channel would first need to know that the data is being spatially encoded. Without this knowledge, it would not be feasible to decode the message. With knowledge that the channel is carrying spatially encoded data, an intercepting party would need to know the manner in which the mask is partitioned into regions, then use that information to assemble a list of the symbols used, and then decipher what each symbol means. Additional enhancements to the security will be provided below.

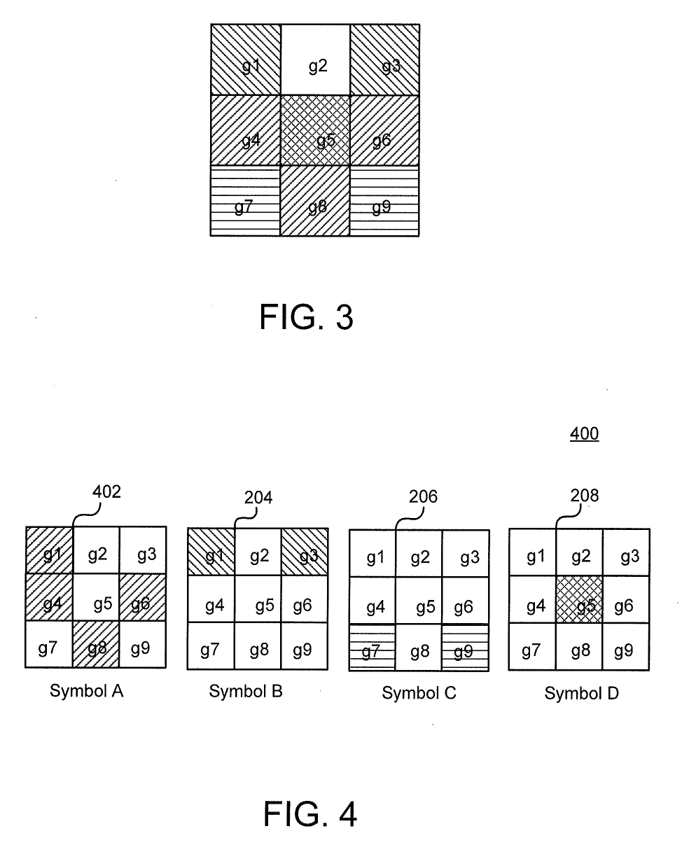

As shown in FIG. 3, the symbols 202, 204, 206, and 208 are defined so that no symbol makes use of a region that is part of another symbol. As such, symbols 202, 204, 206, and 208 do not overlap. In another example, a symbol set may have two or more symbols that overlap each other on a mask, as shown in FIG. 4. FIG. 4 illustrates another example of a symbol set 400 defined by controlling the regions of mask 100. In the depicted example, the symbol set 400 is a set of symbols 402, 204, 206, and 208. The symbol A 402 is formed by setting regions g2, g3, g5, g7, and g9 to the first state and regions g1, g4, g6 and g8 to the second state. Symbol A 402 and symbol B 204 overlap in region g1. In embodiments where symbols do not overlap, or where the overlap of two symbols can still be uniquely decoded as a combination of the two symbols, a protocol can be defined to allow for the superpositioning of symbols. For example, if symbol A 204, 402 and symbol B 204 are to be transmitted, in the order AB, then the superpositioning of symbol A 204, 402 and symbol B 204 can be transmitted. A receiver, following this protocol, would decode the received symbols as AB. If symbol B 204 and symbol A 202, 402 are to be transmitted, they would be transmitted separately to avoid confusion at the receiver.

Those skilled in the art of communications will appreciate that when communicating over a channel, a codebook is formed to associate valid symbols in the code (also referred to as codewords) to data values. Thus, a codebook maps the symbols, such as the symbols in the symbol set 200 to data values. For example, the symbols in set 400 (or 200 of FIG. 2) are A 402, B 204, C 206 and D 208. A 402 can be mapped to a binary value of “00”, B 204 can be mapped to the binary value “01”, C 206 can be mapped to the binary value “10” and D 208 can be mapped to the binary value “11”. The association of each spatially encoded symbol to a binary value forms a codebook. If an encoder receives a data block “00011000” for transmission, this can be divided into “00” “01” “10” and “00”, which would be symbol A 402, Symbol B 204, Symbol C 206 and Symbol A 402. These symbols can be transmitted over an optical link

It will be well understood by those skilled in the art that the symbol sets 200 and 400 are intended to be exemplary. In FIGS. 1-4, the mask 100 has been illustrated as a regular tiling of square or rectangular regions. This has been done for the purposes of simplifying the illustrations and explanatory language. It will be apparent to those skilled in the art that masks of other shapes, and composed of different shaped regions can be used without departing from the intended scope. In examples that will be provided below, some such masks will be illustrated.

As noted above, some of the security provided by the disclosed transmission scheme is provided by the difficulty of determining that the data is being spatially encoded, and then determining how the data is encoded. The question of how the data is encoded using the symbols is a matter of determining the codebook used in transmission. It will be understood that both the transmitter and receiver need to know the codebook being used. For a third party that intercepts the message in transmission, a certain quantity of symbols needs to be recorded to allow for an attack that would allow the third party to identify the codebook in use. The difficulty of such an attack is increased because in an optical channel, buffering the symbols to facilitate the attack is not feasible. To further increase the security, it is possible for a transmitter and receiver to undertake coordinated changes in the codebook used. In one such embodiment, a transmitter will spatially encode data for transmission over an optical channel to a receiver. The transmitter and receiver can perform coordinated changes in the codebook used to spatially encode the data (and to decode the spatial symbols to data). By increasing the frequency with which the codebooks are changed, the difficulty for a third party to decode the symbols increases.

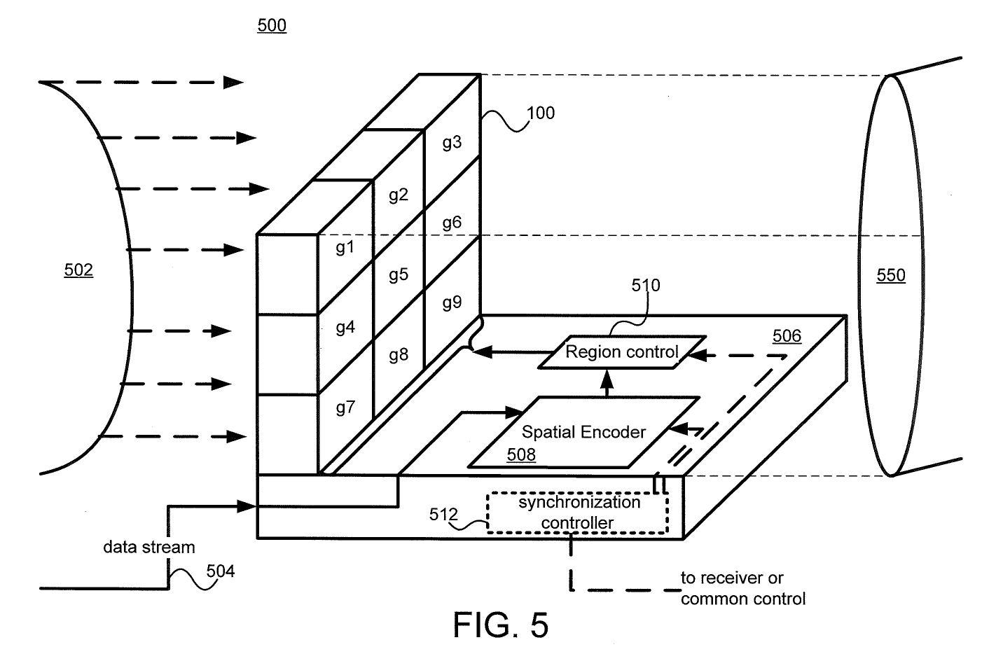

FIG. 5 is a block diagram illustrating an exemplary embodiment of a transmitter 500. A light source 502, typically a laser tuned to a specific wavelength, transmits light towards the optical transmission channel 550. Interposed between the light source 502 and the optical channel 550 is mask 100. Mask 100 is controlled by encoding controller 506 to spatially encode the data stream 504. Light from light source 502, will carry the spatially encoded data through optical channel 550. Data stream 504 is provided as an input to spatial encoder 508. Spatial encoder 508 makes use of the codebook that maps data to symbols (as discussed above) to map the data stream into a series of spatial symbols. The spatial symbols are provided to region controller 510 which, in accordance with the spatial symbols, controls the regions g1-g9 of mask 100. An optional synchronization controller 512 allows the encoding controller 506 to synchronize codebook changes with a receiver. In one implementation, the encoding controller 506 includes a processor and a memory storing instructions executable by the processor for the secure data communication over the optical channel 550. The processor may be configured to perform encoding data into spatial symbols, controlling each region of the mask 100, and/or synchronizing codebook changes with a receiver, as described herein. In an alternate embodiment, each region g1-g9 of mask 100 can be a light source of its own. This could obviate the need for light source 502. The region controller 510 could, based on the information provided by the spatial encoder 508, illuminate the regions of the mask 100 in accordance with the requisite symbol. In such an implementation, regions g1-g9 could be controlled Light Emitting Diodes, and could optionally make use of a light collimator to ensure that the light emitted from each region is strictly contained within the corresponding portion of the optical channel 550.

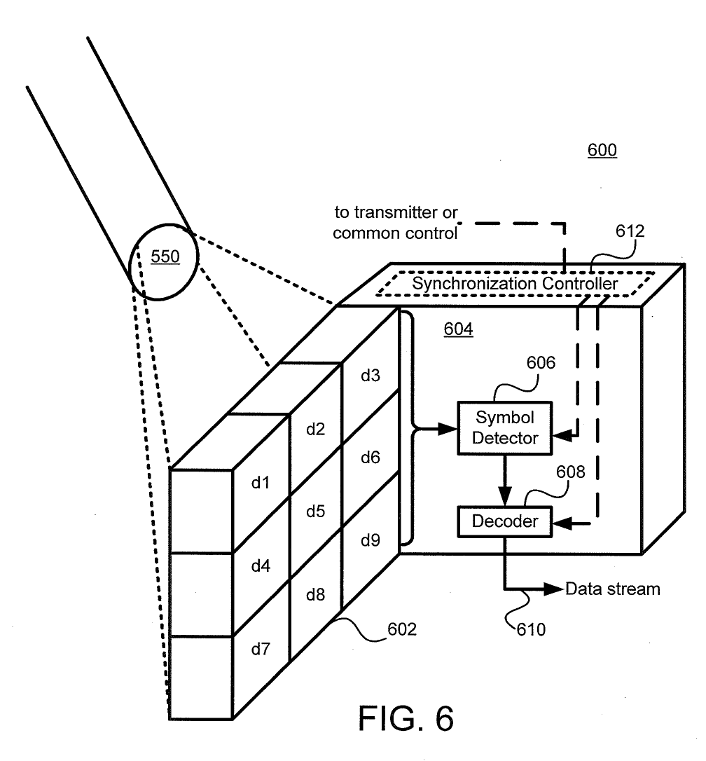

FIG. 6 is a block diagram illustrating an exemplary embodiment of a receiver 600. Spatially encoded symbols are received from optical channel 550 and are projected on a decoding mask 602. Decoding mask 602 is composed of decoding regions d1-d9 which correspond to the regions of encoding mask 100. In an exemplary embodiment, each of decoding regions d1-d9 includes a photodiode, so that when light strikes the region, a signal is generated. The outputs of the decoding regions d1-d9 are provided to a decoding controller 604, which includes a symbol detector 606. Symbol detector 606 uses knowledge of the symbol set, and the signals provided by decoding regions d1-d9 to identify the symbol received from optical channel 550. A decoder 608 converts the identified symbol to a data value. When a stream of symbols is received over channel 550, the decoding mask 602 will provide a series of different input signals to symbol detector 606. This will result in symbol detector 606 providing a stream of identified symbols to decoder 608, allowing decoder 608 to provide as an output a recovered data stream 610. Decoding controller 604 can optionally include a synchronization controller 612 to allow the decoding controller 604 to synchronize codebook changes with a transmitter. In one implementation, the decoding controller 604 includes a processor and a memory storing instructions executable by the processor for the secure data communication over the optical channel 550. The processor may be configured to perform detecting spatial symbols, decoding the symbols and/or synchronizing codebook changes with a transmitter, as described herein. The process may be configured to control each region of the mask 602 in accordance with an encoding scheme of the transmitter 500 shown in FIG. 5.

Those skilled in the art will appreciate that when connected together, the transmitter 500 and receiver 600 can communicate with each other over optical channel 550. The synchronization controllers 512 and 612 can either communicate with each other or with the common control function. The communication can allow for synchronization of the changes in the codebook. One skilled in the art will appreciate that any number of different mechanisms can be used to change the codebook at the transmitter 500 and receiver 600. In one embodiment, a new codebook is generated and transmitted from one of the nodes to the other (or to both of the nodes if a common control is used). In another embodiment, both the transmitter 500 and receiver 600 are provided with a set of indexed codebooks in advance. The synchronization controllers 512 and 612 can communicate with each other so that one or both of the nodes can initiate a change in the codebook. The node that initiates a change simply has to specify which of the codebooks is to be used. As noted above, this could be driven by either of the transmitter or the receiver, or it could be driven by another entity, such as a Software Defined Networking (SDN) Controller.

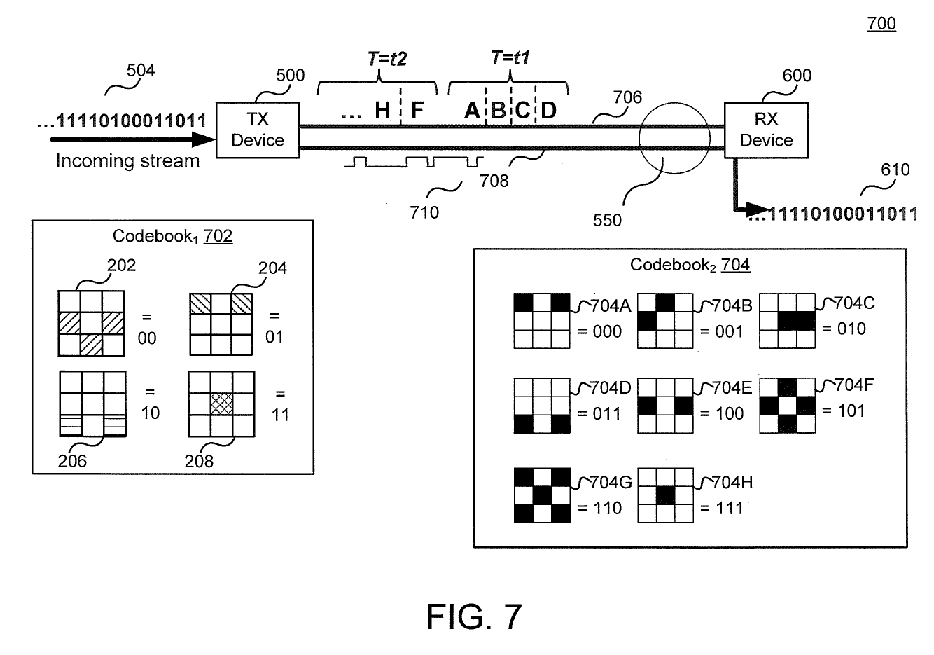

FIG. 7 illustrates an example of an optical system 700 using the secure encoding method discussed above and making use of transmitter 500 and receiver 600. The system 700 includes the transmitter 500 and the receiver 600 communicatively coupled together using optical channel 550. The optical channel 550 may include a free space optics (FSO) link for wireless transmission or a fiber optic link for wired transmission. The optical channel 550 may include any type of optical fibers, which may include, for example, but not limited to, a set of single mode fibers, a multi mode fiber, an orbital-angular-momentum (OAM) fiber, and/or a multi-core fiber. In the depicted example, the optical channel 550 includes a data channel 706 and a control channel 708. The data channel 706 is used for transmission of data (e.g., voice, images, and/or messages). The control channel 708 is used for transmission of various control signals for operation of the system 700.

The system 700 uses Spatial Domain Encoding for data communications over the optical channel 550. A data stream 504 is received by transmitter 500, which uses codebook₁ 702 to encode the data. Codebook₁ 702 is used to perform two-bit encoding, so that two bits of data are encoded into a single symbol. The first two bits of data stream 504 are “11” which is encoded as symbol D 208. The next two bits of data stream 504 are “10” which are encoded as symbol C 206, followed by “01” which are encoded as symbol B 204 and finally “00” which is encoded as symbol A 202. Thus, transmitter 500 will transmit the symbols D 208, C 206, B 204 and A 202 in sequence over the data channel 706. These symbols are transmitted in the first time period t₁. At the receiver 600, the symbols are received and decoded, resulting in the recovery of the first part of data stream 610.

The transmitter 500 and receiver 600 are configured to change various aspects of the spatial encoding and decoding scheme as a function of time. The transmitter 500 and the receiver 600 can communicate with each other over control channel 708 so that they can synchronize the change in codebooks. In this example, transmitter 500 and receiver 600 can store both a set of codebooks, and an ordered list so that a control signal 710 can be used to indicate a change to the next codebook in the ordered list.

As illustrated, when a transition is made to codebook₂ 704, the encoding changes from a 2-bit encoding to a 3-bit encoding. Eight symbols 704A-704I are used. The next set of three bits in data stream 504 is “101” which maps to 704F, followed by “111” which maps to 704H. These symbols are transmitted over data channel 706 in optical channel 550, and are received by receiver 600. Receiver 600 then decodes the received symbols using codebook₂ 704. By coordinating the change in codebooks, the transmitter 500 and receiver 600 are able to communicate with each other which allows for recovery of data stream 610. As noted above, an intercepting party would first be required to determine that the data is being spatially encoded, then would need to determine the codebook in use. By changing the codebook in a coordinated fashion, the transmitter 500 and receiver 600 can protect against any brute force attack (e.g. a statistical analysis attack) on the secure transmission.

The changing of codebooks makes it more difficult for any party, other than the receiver, to be able to decode the message. Optical buffering is not a practical option, so the optically transmitted symbols have to be decoded in real time. As has been described above, a third party would first need to determine that spatial symbols are being used, and would then need to be able to observe the signals in transmission for a period of time before a brute force decoding attempt would be successful. By changing codebooks the process becomes more difficult. The change of the codebook in use should be coordinated at the transmitter and receiver. As shown in FIG. 7, this can be done by signaling in a dedicated control channel. The control channel could be a different wavelength of light in the same optical channel, it could be out of band signaling that uses a different physical connection, it could be in band signaling, it could be at fixed time intervals or after a fixed number of bits are transmitted. Those skilled in the art will appreciate that other techniques may be possible. In some embodiments, inband signaling is used to initiate a change in the codebook. This inband signaling may make use of a defined sequence of symbols that when transmitted are interpreted as an instruction to change the codebook. The sequence of symbols used to initiate a change of encoding schemes may be a set of reserved symbols. One skilled in the art will also appreciate that the decision to change the codebook can be made at the transmitting side, the receiving side, or by another entity, such as a Software Defined Networking Controller.

When codebooks are changed, the symbols used in the codebook may not change, but in such a scenario the data bits assigned to each symbol would change. The changes in the codebook can include any of changing the symbols in the codebook, changing the data value mapped to the symbols, changing the number of symbols in the codebook changing an effective resolution of the mask (e.g. dynamically changing the boundaries between regions on a mask so that the mask could change from a 3×3 grid to a 4×4 grid) and other such codebook changes. It will be understood, that in some codebooks a large number of symbols can be used for a low bit value per symbol encoding. For example, 32 symbols could be used for 2-bit encoding. This may result in a plurality of symbols each being mapped to the same bit value. The transmitter, upon receiving “00” would select one of the plurality of symbols that map to “00” and transmit the selected symbol. At the receiver, receipt of any symbol allows for a simple decoding operation.

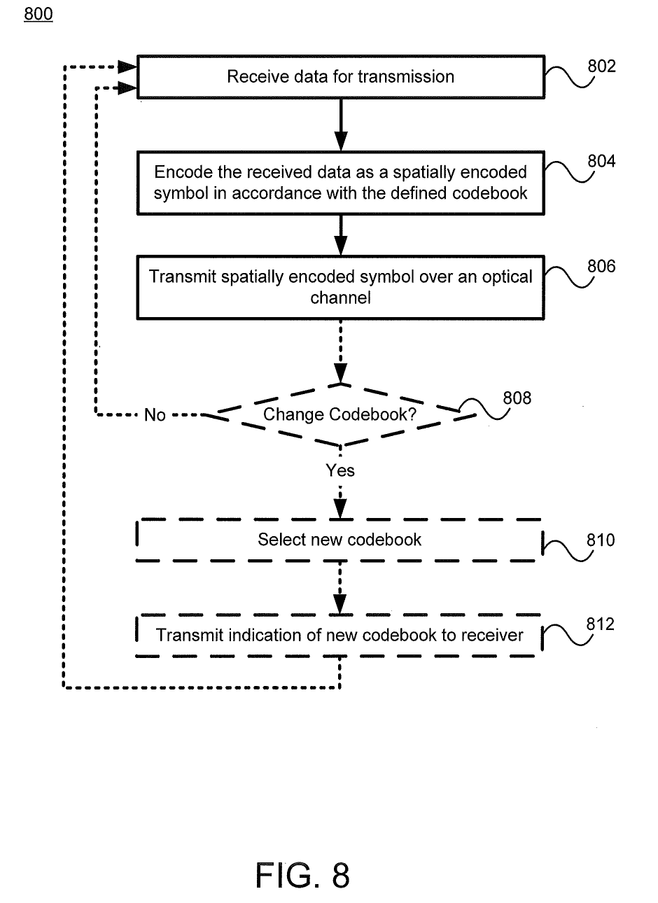

FIG. 8 is a flowchart illustrating one example of a method 800 of spatially encoding data for transmission over an optical channel, which may be implemented in the transmitter 500 of FIG. 5. The method 800 begins with the transmitter receiving data for transmission in step 802. The data to be transmitted may be a continuous stream of data, such as data stream 504, or it could be stored data. In step 804, the received data is encoded as a spatial symbol. The spatial encoding process is done in accordance with a codebook that maps spatial symbols to data values. As indicated above, the spatial encoding may entail mapping multi-bit data blocks to spatial symbols. One skilled in the art will appreciate that although reference has been made to the received data being in the form of bits, there is no requirement for the data to be binary values. Ternary or higher order data could be used with the use of an appropriate codebook. In step 806 the spatially encoded symbol is transmitted over the channel. With reference to FIG. 5, the light source 502 is illuminating the mask 100, which when controlled in accordance with the received data results in a spatial symbol. The light from light source 502 carries the spatial symbol created using mask 100 in accordance with the data through the optical channel 550.

In some embodiments, the security of the transmission method is further buttressed by changing the codebook used for encoding. In step 808, shown as an optional step in dashed lines, a determination of whether the codebook should be changed is made. If the codebook is not to be changed, the method returns to step 802. If the codebook is to be changed, the method continues to step 810. As discussed above, there can be a number of different triggers to initiate the change in the codebook, including changing after a fixed time interval, changing after a fixed number of symbols is transmitted, changing upon receipt of an indication to change etc. In step 810, a new codebook is selected. The selection of a codebook can be performed in accordance with a received indication, in accordance with a preset selection criteria or it can be selected by the transmitter in accordance with any other parameters, or even randomly selected. The selection process can include selecting a codebook from a set of predefined codebooks, or it can include creating a new codebook that maps spatial symbols to data values. In step 812, the transmitter can, if necessary, transmit an indication of the selected codebook to the receiver. This may include the simple transmission of an index value that the receiver can use to select the codebook from an indexed set of codebooks, it could be the transmission of the new codebook, or it could be something in between the two.

The transmitter may utilize a dynamic look up table to switch among a plurality of codebooks. The codebooks may be generated by using a cryptographically secure pseudorandom sequence. Codebooks contain a reversible mapping between data sequences and symbols. The symbols can be spatial patterns represented by geometric patterns created on the mask. By having each codeword map to a data sequence, an incoming data sequence can be represented by a set of symbols that can be mapped back to a data sequence at the receiver.

It will be understood that the step 800 of receiving data for transmission, may in many systems include receiving data for transmission from a single source. In other embodiments, data from a plurality of data sources is aggregated to create a single data stream. In some such embodiments of aggregation, bits from a plurality of different sources can be combined in a manner that is predefined at both the transmitter and receiver. For example, if there are four sources that are transmitting synchronously, one bit from each of the sources can be taken in a defined order, and the four bits are then encoded and transmitted. After decoding the symbols at a receiver, a demultiplexer would be able to separate the data coming from each source.

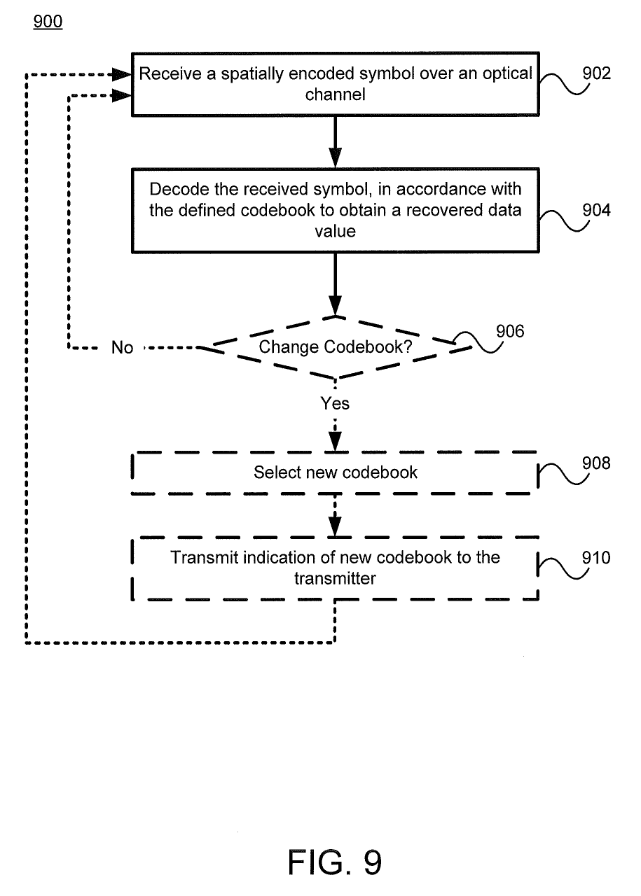

FIG. 9 is a flowchart illustrating one example of a method 900 for decoding spatially encoded data received over an optical channel. In step 902, a spatially encoded symbol is received over an optical channel. The received symbol is identified and decoded in accordance with a defined codebook in step 904. The processes of identifying and decoding may be separate, or they can be performed together in a single module (effectively combining the functions of the symbol detector 606 and the decoder 608 of FIG. 6). This results in the recovery of the transmitted data. If a plurality of symbols is transmitted, the result will be a recovered data stream, such as data stream 610.

In step 906, shown in dashed lines to indicate that it is optional, a determination is made as to whether the codebook used to decode the spatially encoded symbols should be changed. If no change in codebook is required, then the process returns to step 902. If the codebook is to be changed, the process proceeds to step 908 where the new codebook is selected. The determination in step 906 can be made in accordance with any of the number of symbols received since the last codebook change, with the time elapsed since the last codebook change, in accordance with an indication received from the transmitter or a third party, in accordance with a determination made at the receiver, or other mechanisms that will be apparent to those skilled in the art. The selection of the codebook can be performed in accordance with a received indication (including an indication that the codebook should be changed), in accordance with a preset selection criteria or it can be selected by the receiver in accordance with any other parameters. If the receiver selects the codebook in step 908, it can also transmit an indication of the new codebook towards the transmitter.

In the above discussion, reference has been made to the transmissions being carried in an optical channel. Those skilled in the art will appreciate that any number of different optical channels can be used, so long as the channel will support the transmission of spatial symbols. In one embodiment, a free space optical channel is used. In another embodiment, an optical fiber is employed as the optical channel. While conventional single mode optical fiber directs the energy of the signal into the core of the fiber, other types of fiber, including Optical Angular Momentum (OAM) fibers, multimode fiber, multicore fiber and hollow core fiber can be employed to more easily allow for spatial encoding. A hollow core fiber can be thought of as a free space optical channel that is contained within a fiber, thus allowing for the channel itself to be bent (within the curvature constraints of the fiber) which removes the conventional free space optics restriction of a line of sight channel. An OAM fiber allows propagation of the signal through OAM modes. These modes at typically spatially separated from each other. In some existing uses, OAM fibers are used to increase the capacity of the channel by allowing transmission of signals through different regions of the fiber (each region corresponding to an OAM mode). The transmission methods disclosed above make use of the excitation of different OAM modes to form the symbol itself.

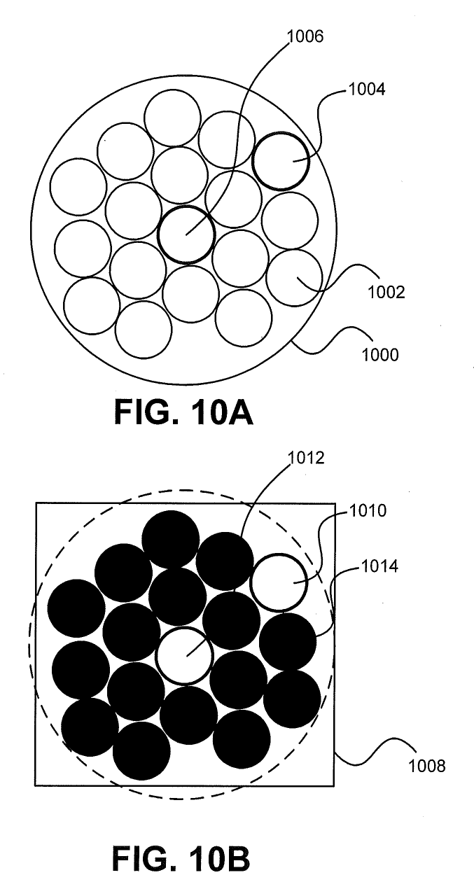

Multicore fibers have a plurality of transmission cores within a single cladding. FIG. 10A is a representation of the cross section of a multicore fiber 1000. The fiber 1000 has a plurality of cores 1002 through which a signal can be carried. In the illustrated example, two of the cores, core 1004 and core 1006, will be used to carry the light, forming a symbol. A corresponding mask 1008 is illustrated in FIG. 10B. The mask 1008 is made up of a plurality of regions 1014, two of which (regions 1010 and 1012) are set to a first state which allows transmission of light, while the remaining are opaque. Much as with mask 100, each region can be individually controlled to allow for the propagation of the light. At a receiver, a decoding mask can be similar in structure to decoding mask 602, but arranged in a different geometric form. In this way, the cores 1002 of the multicore fiber 1000 can be used as the optical channel 550, with the symbols being created by the selection of regions 1014 in mask 1008.

It will be well understood that an optical channel can be used with a plurality of different wavelengths. The above described method of transmission may include transmitting another signal in the regions of the channel that are not being used to transmit the encoded data stream. These other signal may be noise, or they may be legitimate signals which may or may not be securely encoded. The other signal may be transmitted on a different wavelength, making it more difficult for an intercepting party to discern a pattern. By including a specified wavelength in the codebook, the receiver will not have the same problems.

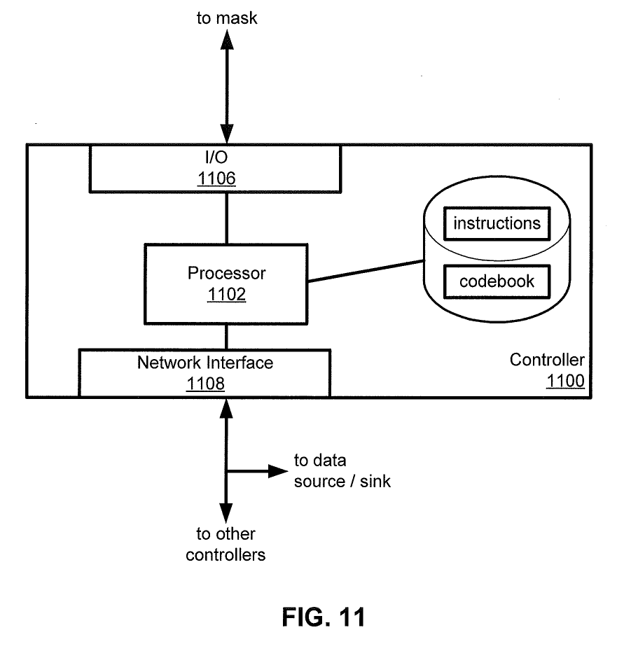

FIG. 11 is a block diagram illustrating a computing platform upon which a controller 1100, such as encoding controller 506 or decoding controller 604 can be implemented. Controller 1100 has a process 1102 connected to a memory 1104. Memory 1104 can store the codebook for use in encoding or decoding as the case may be. Memory 1104 can also store instructions that when read and executed by the processor will cause the controller 1100 to carry out encoding and decoding methods, such as those discussed above. An Input/Output (I/O) interface 1106 is connected to the processor 1102, and is an interface to the encoding or decoding mask. In embodiments in which the controller 1100 is an encoding controller, I/O 1106 allows the controller to configure the mask 100 so that the symbols can be created. In embodiments in which the controller 1100 is a decoding controller, I/O 1106 allows the signal from the mask indicative of the received symbol to be received by the controller. Network interface 1108 allows an optional interface to other controllers, such as the controller at the other end of the optical channel, or to a common control. Network interface 1108 also connects the controller to the source of the data stream, or to the sink of the recovered data stream.

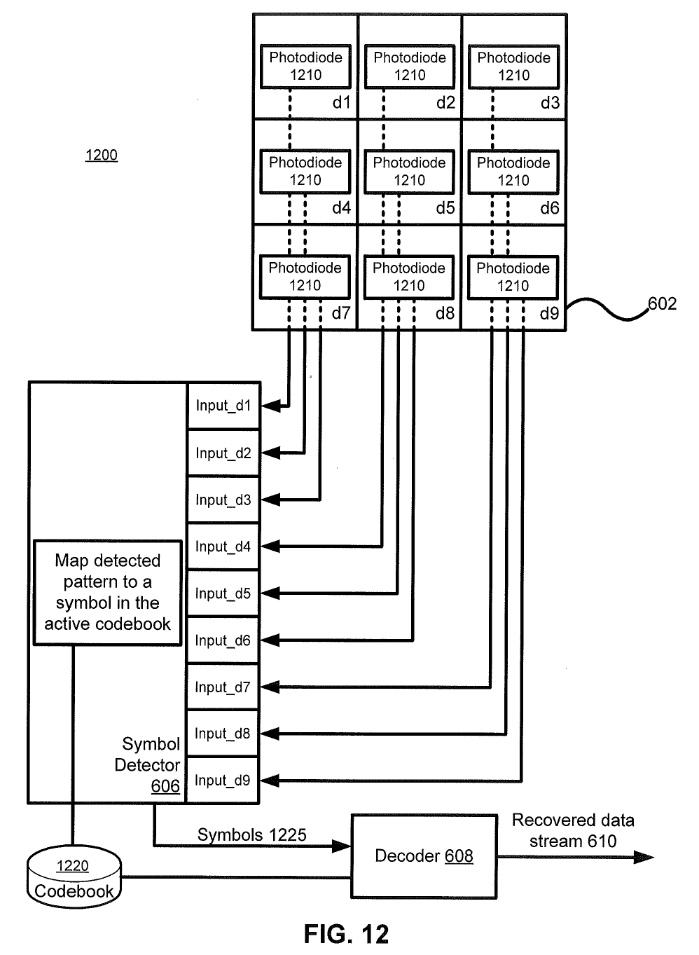

FIG. 12 illustrates one example of an implementation 1200 of components in the receiver of FIG. 6. As shown in FIG. 6, mask 602 is made up of regions d1-d9. As shown in FIG. 12, each of these regions can contain a photodiode 1210 or other light sensor. As light from channel 550 is directed to mask 602, it will illuminate the regions corresponding to the transmitted symbol. Because each of the regions has a photodiode 1210, an illuminated region will generate a different electrical signal as output than a non-illuminated symbol. Symbol detector 606 includes input registers corresponding to each of the regions d1-d9 in mask 602. As a spatial symbol is received as mask 602, photodiodes 1210 in each of regions d1-d9 generate signals representative of the received spatial symbol. These generated signals are provided to input_d1-input_d9 respectively, and allow symbol detector 606 to map the detected spatial pattern to a symbol in the codebook 1220. Those skilled in the art will appreciate that codebook 1220 can be fixed or changing, as described in the above embodiments. Symbol detector 606 outputs symbols 1225 in accordance with the patterns corresponding to the received spatial symbol and the codebook 1220. Decoder 608 receives the symbols 1225, and in accordance with the codebook 1220 converts the symbols 1225 into the recovered data stream 610. Those skilled in the art will appreciate that the symbol detector 606 and decoder 608 can be combined in a single logical function, but are shown as separate functions in this drawing to aid in the understanding of the operation of the system.

Any discussion of processing in the above description may be implemented by causing a processor, digital signal processors (DSP), application-specific integrated circuit (ASIC), or components of a processor in the systems shown in FIGS. 5, 6, and 7 to execute a computer program or provide functions, methods and processes as described herein. In this case, a computer program product can be provided to a computer using any type of non-transitory computer readable media. The computer program product may be stored in a non-transitory computer readable medium in the computer or the network device. Non-transitory computer readable media include any type of tangible storage media. Examples of non-transitory computer readable media include magnetic storage media (such as magnetic tapes, hard disk drives, flash memory, etc.), optical magnetic storage media (e.g. magneto-optical disks), compact disc read only memory (CD-ROM), compact disc recordable (CD-R), compact disc rewritable (CD-R/W), digital versatile disc (DVD), Blu-ray (registered trademark) disc (BD), and semiconductor memories (such as mask ROM, programmable ROM (PROM), erasable PROM), flash ROM, and RAM). The computer program product may also be provided to a computer or a network device using any type of transitory computer readable media. The term “configured to (perform a task)” as used herein includes being programmable, programmed, connectable, wired or otherwise constructed to have the ability to perform the task when arranged or installed as described herein.

While one or more embodiments have been provided in the present disclosure, it may be understood that the disclosed systems and methods may be embodied in many other specific forms without departing from the scope of the present disclosure. The present examples are to be considered as illustrative and not restrictive, and the intention is not to be limited to the details given herein. For example, the various elements or components may be combined or integrated in another system or certain features may be omitted, or not implemented. A number of variations and modifications can be made without departing from the scope of the invention as defined in the claims.

What is claimed is:

1. A transmitter for secure data transmission over an optical channel, comprising:
a mask for transmitting a spatial symbol into the optical channel; and
a controller configured to:
encode incoming data as a spatial symbol in accordance with a first codebook, and
control the mask based on the spatial symbol to transmit the spatial symbol through the optical channel.

2. The transmitter of claim 1 wherein the mask is disposed between a light source and the optical channel.

3. The transmitter of claim 1, wherein the controller comprises a region controller configured to control each of a plurality of regions of the mask based on the symbol.

4. The transmitter of claim 2, wherein each region in the plurality is operable as one of a polarizer, an attenuator, a phase shifter, a dispersive element and combinations thereof.

5. The transmitter of claim 1, wherein the transmitter is configured to change the codebook.

6. The transmitter of claim 5 wherein the transmitter is configured to change the codebook in response to one of:
a message received from a controller;
a message received from a receiver of the spatial symbol;
a timer internal to the transmitter; and
detection of an event.

7. The method of 6 wherein the transmitter is further configured to notify at least one of the receiver and the controller of a change of the codebook.

8. The transmitter of claim 5 wherein the transmitter is configured to:
generate a second codebook different from the first codebook; and
use the second codebook in a subsequent encoding.

9. The transmitter of claim 5 wherein the transmitter is configured to receive a new codebook from a controller or a receiver.

10. The transmitter of claim 1, wherein the controller comprises a spatial encoder configured to map the incoming data to the spatial symbol in accordance with the codebook.

11. A method for secure data transmission over an optical channel, comprising:
encoding incoming data as a spatial symbol in accordance with a codebook; and
transmitting the spatial symbol through the optical channel.

12. The method of claim 11, comprising:
controlling the configuration of a mask to transmit light into the optical channel in accordance with a shape of the spatial symbol.

13. The method of claim 12, wherein transmitting includes transmitting a light through the mask.

14. The method of claim 12, wherein controlling the mask comprises controlling each of a plurality of regions of the mask based on the symbol.

15. The method of claim 11, comprising changing the codebook after transmitting the spatial symbol.

16. The method of claim 15, comprising instructing a receiver to change a codebook for data decoding in the receiver.

17. A receiver for secure data communication over an optical channel, comprising:
a mask for generating a signal based on detection of a spatially encoded symbol received over the optical channel; and
a controller configured to:
identify the received symbol in accordance with the generated signal;
decode the spatial symbol into a data value in accordance with a codebook.

18. The receiver of claim 17, wherein the controller is further configured to identify the received symbol in accordance with the generated signal and the codebook.

19. The receiver of claim 17, wherein the receiver is configured to change the codebook.

20. The receiver of claim 19 wherein the receiver is configured to change the codebook in response to one of:
a message received from a controller;
a message received from a transmitter of the detected spatially encoded symbol;
a timer internal to the receiver; and
detection of an event.

21. The receiver of claim 19, wherein the receiver is configured to instruct a transmitter communicatively coupled to the receiver to change a codebook for data encoding in the transmitter.

22. A method for decoding spatially encoded data received over an optical channel, comprising:
generating a signal based on spatially encoded data received over the optical channel;
identifying a spatial symbol from the signal; and
decoding the spatial symbol into a data value in accordance with a codebook.

23. The method of claim 22 wherein identifying the spatial symbol includes identifying the spatial symbol in accordance with the codebook.

24. The method of claim 22, comprising changing the codebook after decoding the spatial symbol.

25. The method of claim 22, comprising instructing a transmitter to change a codebook for data encoding in the transmitter.
